(19) United States
(12) Patent Application Publication
(10) Pub. No.: US 2005/0274033 A1
(43) Pub. Date: Dec. 15, 2005

(54) Knockout alignment device for electrical panel boxes

(76) Inventor: Wilhelm Kraemer, Robbinsville, NJ (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/151,530

(22) Filed: Jun. 14, 2005

Related U.S. Application Data
(60) Provisional application No. 60/579,253, filed on Jun. 15, 2004.

(51) Int. Cl. G01D 21/00

(52) U.S. Cl. 33/645

(57) ABSTRACT

A kit, method and device to insure proper alignment of a knockout hole cutter for creating holes in an enclosure is disclosed. An alignment sleeve comprising a plurality of indicators is configured to fit over an alignment part of the knockout hole cutter and is preferably flexible. The indicators of the sleeve are used to align the knockout hole cutter on the surface of the electrical enclosure.

### CROSS REFERENCE TO RELATED APPLICATION

This application claims the benefit under 35 U.S.C. §119(e) of a U.S. provisional patent application entitled “Knockout Alignment Device for Electrical Panel Boxes”, which was filed in the U.S. Patent and Trademark Office on Jun. 15, 2004 and assigned Ser. No. 60/579,253, the entire content of said application being incorporated herein by reference.

### FIELD OF THE INVENTION

The present invention relates generally to an alignment device for use in the construction industry. More specifically, the present invention relates to an alignment device for cutting knockout holes in electrical enclosures for conduit, such as the type used by electricians for carrying electrical wires.

### BACKGROUND OF THE INVENTION

It is often necessary in the construction industry for electric wires to be carried within conduit, such as metal or plastic piping. Typically, holes are drilled into electrical enclosures by electricians to properly align the conduit before installing the conduit. These holes are commonly referred to as pilot holes. After drilling the pilot holes, the electrician uses a device known as a knockout hole cutter to precisely cut an entry or knockout hole through the surface of the electrical enclosure.

The importance of properly aligned entry holes in electrical enclosures to an efficient electrical wiring job cannot be overstated. First of all, the electrician's job is made easier if the knockouts in any enclosure are aligned because this insures that the conduit may be bent without having to account for alignment errors in the bends of other conduit entering the same enclosure. Proper alignment helps prevent the several pieces of conduit that typically enter an enclosure from interfering with one another.

The entry holes are usually measured to fractions of an inch and typically there are a number of holes in each enclosure; therefore, accurate and neat formation of the properly sized and number of entry holes can become complex and extremely time consuming. This is particularly the case if a large number and variety of sizes of conduit are required, and especially if holes of the same size are also required to permit exit of the same conduit through another surface of the same enclosure. For example, standard knockout hole kits may provide several size cutters ranging from three-quarters of an inch to one and one-half inch cutters. Other kits may include cutters for conduit sizes ranging from a half-inch to five inches. If several rows and columns of conduit with possibly various sizes are required, cutting the conduit entry holes becomes time consuming and tedious. Furthermore, errors often occur as a result of the existing method of aligning knockout hole cutters. Such errors result in duplication of effort as well as wasted material.

Besides having to properly make alignment marks on the enclosure surface, the actual entry point may be misaligned if the pilot holes are not properly drilled. Since the conduit may measure several inches in diameter, the pilot holes made by drilling are typically a standard size. Knockout devices having alignment parts of various diameters are then used to cut the larger entry holes in the electrical enclosures. If the alignment part of the knockout device is misaligned, there is no way to easily correct such a mistake after the fact. Both the enclosures and the conduit are expensive and multiple mistakes reflect poorly on the electrician making such mistakes.

There is a need for a device that reduces the tedium of aligning the knockout device, provides an alignment indicator with high visibility, and is easy to use. Also, because of the rugged construction environment, the device should be able to withstand abuse above and beyond normal wear and tear.

### SUMMARY OF THE INVENTION

The present invention solves the problem of properly aligning the alignment part of the knockout hole cutter with the alignment markings made on the electrical enclosure. The present invention provides an alignment sleeve with indicators which fits around the alignment part of the knockout hole cutter. The alignment sleeve indicators are preferably four extensions, configured similarly to the four points of a compass, that are aligned with the markings on the electrical enclosure. In addition, the indicators of the alignment sleeve are preferably flexible and are easily visible in low light conditions.

The above features, and others, will be more evident in light of the following detailed description of embodiments of the invention.

### BRIEF DESCRIPTION OF THE DRAWINGS

The present invention will be more readily understood with reference to the embodiments thereof illustrated in the attached drawings, in which:

FIG. 1 is an exploded view of a conventional knockout hole cutter being used on an electrical enclosure;

FIG. 2 is a perspective view of a conventional knockout hole cutter in position to begin cutting after being aligned with the alignment markings;

FIG. 3 is an exploded view of an alignment sleeve with indicators used in combination with a conventional knockout cutter according to an embodiment of the present invention; and

FIG. 4 is a perspective view of another embodiment of the present invention showing the alignment of the alignment sleeve indicators with the electrical enclosure alignment markings.

It is to be understood with respect to the detailed description of the exemplary embodiments of the present invention that like reference numbers refer to like parts and structures within the several drawings.

### DETAILED DESCRIPTION OF EXEMPLARY EMBODIMENTS

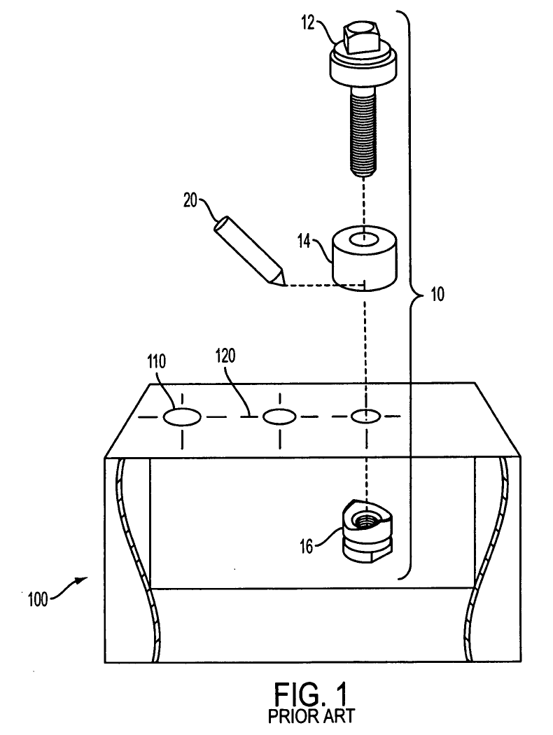

Existing knockout devices will be described with respect to FIG. 1. Knockout hole cutter 10 typically comprises three parts: a threaded connecting bolt or draw stud 12, an alignment part or die 14, and a cutter or punch 16. Threading connecting bolt 12 fits through alignment part 14 and screws into the threads of cutter 16. The alignment part 14 and cutter 16 are provided in a variety of sizes corresponding to the various sizes of conduit. Obviously, the alignment part 14 and the cutter 16 must correspond to the same size conduit to make the proper opening 110 for the conduit. Marking material 20 is used to visibly mark the notches 15 in the alignment part 14 so that the notches 15 will be highlighted. Typically, there are four notches 15 in the alignment part 14 and each is given a visible mark to insure accurate alignment. Marking material 20 may be a pencil, an ink pen, a marker, or the like, so long as the marking material 20 leaves a visible mark on the alignment part.

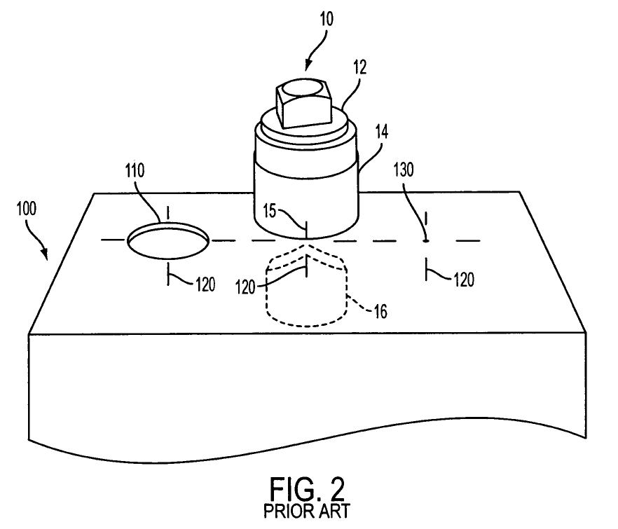

The conventional method of using the knockout hole cutter 10 will now be described in detail. First, alignment markings 120 are made on the surface of the electrical enclosure 100. A pilot hole 130, as shown in FIG. 2, is drilled into the electrical enclosure 100, preferably centered between the alignment marks 120. The pilot hole 130 is smaller than the opening 1 10 required by the conduit entering the enclosure 100. However, the pilot hole 130 is usually made large enough to allow clearance for the threaded connecting bolt 12 to move laterally in any direction to compensate for any misalignment of the pilot hole 130 with the alignment marks 120.

The threaded connecting bolt 12 is then inserted into the alignment part 14. The alignment part 14 is typically larger than the entry hole 110 needed for the conduit to fit into the enclosure. Marking material 20 is then used to visibly mark the notches 15 in the alignment part 14. The threaded connecting bolt 12 with the alignment part 14 is placed into the pilot hole (shown in FIG. 2 as 130) in the electrical enclosure 100 until stopped by the alignment part 14. Cutter 16 is then screwed onto the threaded connecting bolt 12 from inside the electrical enclosure 100.

FIG. 2 shows the knockout hole cutter 10 in position to cut a new entry hole 110 through the electrical enclosure 100. As can be seen, notch 15 is aligned with alignment mark 120 prior to the entry hole 110 being made by the knockout hole cutter 10. To insure complete accuracy, alignment marks 120 should intersects with each of the notches 15 on alignment part 14. At times, however, the entry holes 110 for the conduit may be close together and alignment marks 120 may become obstructed by either the presence of another entry hole 110 or by pre-existing conduit located near the location of new entry hole 1 10, and the notch 15 cannot be aligned with the alignment mark 120. Additionally, the lighting conditions in the areas where the electrical enclosures 100 are located may not be adequate to see the marks made on the notches 15 of the alignment part.

The threaded connecting bolt 12, alignment part 14 and cutter 16 are tightened to the respective sides of the electrical enclosure 100 to verify the final alignment of the to-be-cut entry hole 110 by confirming the alignment of the marked notches 15 with the alignment marks 120. Further tightening of the threaded connecting bolt 12 causes the curved sharp edges of cutter 16 to cut through the side of the electrical enclosure 100.

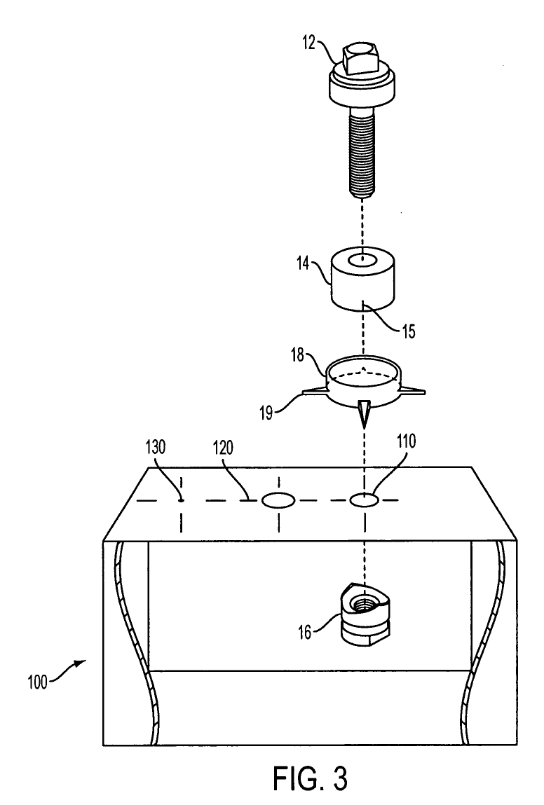

A method of using the alignment sleeve 18 according to an embodiment of the present invention will now be described with reference to FIG. 3. The threaded connecting bolt 12, alignment part 14 and cutter 16 are identical to those previously described. An alignment sleeve 18 with indicators 19 is used to avoid the necessity of marking the notches 15 with a marking material 20. The threaded connecting bolt 12 is inserted into the alignment part 14, but rather than marking the notches 15 as in the prior art, the user now inserts the alignment part 14 into the alignment sleeve 18. Because of the circular nature of the alignment part 14 in this embodiment, the precise alignment of the indicators 19 on the alignment sleeve 18 with the notches 15 on the alignment part 14 is not necessary. In other embodiments, where the configuration of alignment part 14 is not circular, such as in D-shaped and double D-shaped knockouts, more care may be needed to properly align alignment part 14 with the alignment sleeve 18. The indicators 19 may be from one-eighth of an inch to one inch in length from the alignment sleeve 18. However, the indicators 19 may be of any length that is easily visible by a user.

Alignment sleeve 18 is preferably configured to have four indicators 19 extending out from the sides of the alignment sleeve 18 at 90° angles from one another (90°, 180°, 270° and 360°) around its perimeter. These four indicators 19 correspond to the typically four alignment marks 120 made on the surface of the electrical enclosure 100. As in the prior art, pilot holes 130 are drilled into the electrical enclosure 100 preferably centered between alignment marks 120. After assembling threaded connecting bolt 12, alignment part 14 and alignment sleeve 18, the assembled parts are placed into the pilot hole 130 and the cutter 16 is screwed onto threaded connecting bolt 12. The indicators 19 on the alignment sleeve 18 are aligned with the alignment marks 120. After tightening the threaded connecting bolt 12 and cutter 16 together to be snug against the surface of the electrical enclosure 100, the alignment of the indicators 19 with the alignment marks 120 is verified, and entry hole 110 is cut.

Although four indicators 19 are shown, additional indicators 19 may be located between the indicators shown. These additional indicators may, for example, be located at the 45°, 135°, 225° and 31520 positions around the perimeter of the alignment sleeve 18. These additional indicators 19 may be shorter in length than the indicators 19 located at the 90° positions (90°, 180°, 270° and 360°) so that they can be easily distinguished.

With regard to the shape of the indicators 19, although shown as triangular, the indicators 19 may extend straight out from the alignment sleeve 18 and then gradually taper to a point, in a shape that is substantially triangular. Alternatively, any indicator 19 with a shape that facilitates the proper alignment of the alignment part 14 can be used.

In the prior art, the alignment marks 120 may be drawn too short to meet the notches 15 on alignment part 14, which increases the chances of misalignment. However, because the indicators 19 of alignment sleeve 18 extend outward from the alignment part 14 as compared to the notches 15 of the prior art, the chance that the alignment marks 120 will be drawn too short for proper alignment is reduced. After being properly aligned using the indicators 19, the knockout hole cutter 10 is used, as in the prior art, to cut out the entry hole 110.

The indicators 19 are preferably brighter in color than the upper portion 28. Therefore, the user will be able to see the brighter colored indicators 19 in low light conditions. The colors of the indicators 19 are preferably bright colors such as white, orange, red, green, pink or yellow. The material from which the indicators 19 are made may be a glow-in-the-dark or fluorescent material.

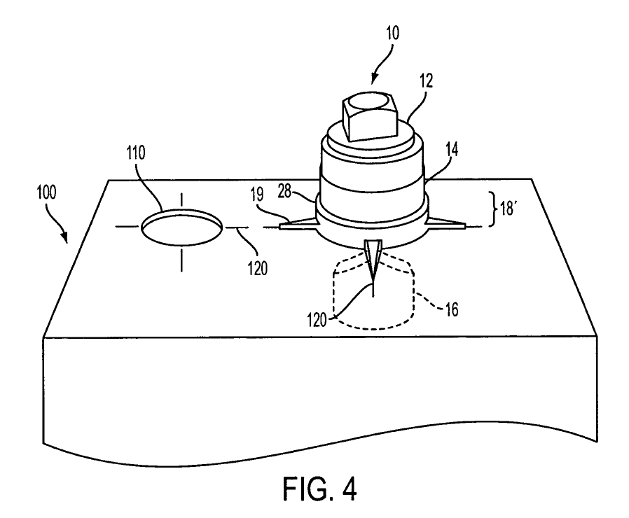

FIG. 4. illustrates an alternative configuration of alignment sleeve 18′ comprising an upper portion 28 and indicators 19. Both the upper portion 28 and the indicators 19 of the alternative configuration of the alignment sleeve 18′ may be made of a flexible material. Another alternative embodiment uses a more rigid upper portion 28 for the alignment sleeve 18′ that fits snugly to alignment part 14 with the indicators 19 being formed of a more flexible material. In this embodiment, the upper portion 28 may be made of plastic, metal or some other suitable material that is more rigid than the material used for the indicators 19. Also, the upper portion 28 may be color-coded based on the size of the conduit for which the knockout may be used. The more rigid upper portion 28 provides additional strength to the alignment sleeve 18′, which increases its durability in the harsh construction environment. Finally, the knockouts 10 may be used for not only making circular entry holes 110, but alternatively to form a variety of hole shapes, such as D-shaped or double D-shaped holes, or key punches. The alignment sleeve 18′ comprising upper portion 28 and indicators 19 may also be shaped to snugly fit the alignment parts 14 used in the non-circular shaped knockouts 10, such as D-shaped and double D-shaped knockouts.

The alignment sleeve 18 or 18′ may be made of any number of materials with various configurations, as long as the alignment sleeve 18 or 18′ provides the desired alignment function. The alignment sleeve 18 or 18′ is preferably made of an elastic or flexible material to insure a snug fit over the alignment part 14. Preferably, the indicators 19 of the alignment sleeve 18 or 18′ are flexible, which prevents them from breaking and also allows the indicators 19 to bend when the clearance between existing conduits or other objects is minimal. In these embodiments, alignment sleeve 18 or 18′ may be made of natural rubber, synthetic rubber or any other natural or man-made material that provides the above described properties.

Embodiments of the present invention may be formed by using a two-shot injection mold to provide materials of different colors and properties. However, other suitable methods of manufacture may also be employed to manufacture embodiments of the present invention.

While there have been described preferred embodiments of the invention, those skilled in the art will recognize that other and further modifications may be made hereto without departing from the scope of the invention, and it is intended to claim all such modifications falling within the true scope of the invention.

1. An alignment device for use with a knockout hole cutter for forming holes in an electrical enclosure, comprising:
an alignment sleeve that fits on an alignment part of the knockout hole cutter;
a plurality of indicators attached to the alignment sleeve, wherein the plurality of indicators indicate the alignment of the knockout hole cutter with respect to the enclosure.

2. The alignment device of claim 1, wherein the alignment sleeve and indicators are made of the same flexible material.

3. The alignment device of claim 1, wherein the alignment sleeve is made of a material different from the material used for the indicators.

4. The alignment device of claim 1, wherein the alignment sleeve and indicators are made by an injection molding process.

5. The alignment device of claim 1, wherein the alignment sleeve fits snugly around the alignment part of the knockout hole cutter.

6. The alignment device of claim 5, wherein the alignment sleeve is made of an elastic material.

7. The alignment device of claim 1, wherein the length of at least one of the indicators is approximately one-eighth of an inch.

8. The alignment device of claim 1, wherein the indicators are evenly spaced from one another on the alignment sleeve around the perimeter of the alignment part of the knockout hole cutter.

9. The alignment device of claim 8, wherein the indicators are four in number.

10. The alignment device of claim 1, wherein the indicators are substantially triangular in shape.

11. The alignment device of claim 1, wherein the indicators are of a color selected from the group consisting of white, yellow, orange, red, green and pink.

12. The alignment device of claim 12, wherein the material from which the indicators are made is fluorescent.

13. A method for aligning a knockout hole cutter on an enclosure, wherein the knockout hole cutter comprises an alignment part, a threaded connecting part and a cutting part, comprising the steps of:
inserting the alignment part of the knockout hole cutter into an alignment sleeve, wherein the alignment sleeve comprises a plurality of indicators;
aligning at least one of said plurality of indicators with an alignment marks on a surface of an enclosure;
tightening said knockout hole cutter to the surface of the enclosure; and
verifying that said at least one indicator of the alignment sleeve continues to be aligned with the alignment marks on the surface of the enclosure.

14. The method of claim 13, wherein the indicators of the alignment sleeve are four in number.

15. The method of claim 14, wherein the four indicators are aligned with corresponding alignment markings on the surface of the enclosure.

16. A kit of parts for forming holes in an enclosure, the kit comprising:
a knockout hole cutter comprising an alignment part, a threaded connecting bolt and a cutter; and
a alignment sleeve that fits snugly around the alignment part of the knockout hole cutter for aligning the knockout hole cutter to a surface of an enclosure, wherein the alignment sleeve comprises a plurality of indicators.

17. The kit of claim 16, wherein the alignment sleeve and indicators are made of the same flexible material.

18. The kit of claim 16, wherein the alignment sleeve is made of a material different from the material used for the indicators.

19. The kit of claim 16, wherein the indicators are substantially triangular in shape.
